(19) United States
(12) Patent Application Publication
(10) Pub. No.: US 2025/0196234 A1
(43) Pub. Date: Jun. 19, 2025

(54) CUTTING TOOL, AND METHOD FOR MANUFACTURING MACHINED PRODUCT

(71) Applicant: KYOCERA CORPORATION, Kyoto (JP)

(72) Inventor: Shosei GOTO, Kyoto (JP)

(21) Appl. No.: 18/846,275

(22) PCT Filed: Mar. 8, 2023
(86) PCT No.: PCT/JP2023/008802

§ 371 Date: Sep. 12, 2024

(30) Foreign Application Priority Data
Mar. 16, 2022 (JP) 2022-041732

(51) Int. Cl. B23C 5/02; B23B 29/03

(52) U.S. Cl. CPC B23C 5/02; B23B 29/03

(57) ABSTRACT

A cutting tool includes a shaft portion having a cylindrical shape, a first protrusion protruding from the shaft portion toward an outer periphery and having a first cutting edge at an end portion of the outer periphery, a second protrusion protruding from the shaft portion toward the outer periphery and having a second cutting edge at an end portion of the outer periphery, and a first beam located away from the shaft portion and connected to the first protrusion and the second protrusion. The second protrusion is located behind the first protrusion with respect to a rotation direction of a rotation axis, and the first beam has a projecting shape protruding toward the outer periphery in a view at a side of the front end.

### TECHNICAL FIELD

The present disclosure relates to a cutting tool and a method for manufacturing a machined product. An example of the cutting tool is a so-called rotary tool. The rotary tool may include a milling tool and a boring tool. The boring tool may be used for machining an inner peripheral surface of a cylindrical workpiece.

### BACKGROUND OF INVENTION

For example, rotary tools described in Patent Documents 1 to 3 are known as cutting tools. When a rotary tool is used as a milling tool, chips are discharged to the outside as they advance toward an outer periphery side. On the other hand, when the rotary tool is used as a boring tool, chips are discharged to the outside as they advance toward a rear end side. Therefore, it is necessary to ensure both a space for discharging chips and strength of the cutting portion. For example, the cutting tool described in Patent Document 3 has a rim connecting a plurality of pockets to which cutting inserts are attached. The rim is spaced apart from a central hub to allow chips to flow through a gap between the rim and the central hub.

### CITATION LIST

### Patent Literature

Patent Document 1: JP 2019-511385 T
Patent Document 2: US 2021/0060665 A
Patent Document 3: US 2014/0161543 A

### SUMMARY

A cutting tool according to a non-limiting aspect of the present disclosure includes a shaft portion having a cylindrical shape and extending along a rotation axis from a front end toward a rear end, a first protrusion protruding from the shaft portion toward an outer periphery and having a first cutting edge at an end portion of the outer periphery, a second protrusion protruding from the shaft portion toward the outer periphery and having a second cutting edge at an end portion of the outer periphery, and a first beam located away from the shaft portion and connected to the first protrusion and the second protrusion. The second protrusion is located behind the first protrusion with respect to a rotation direction of the rotation axis, and the first beam has a projecting shape protruding toward the outer periphery in a view at a side of the front end.

### BRIEF DESCRIPTION OF THE DRAWINGS

FIG. 1 is a perspective view illustrating a cutting tool of a non-limiting embodiment of the present disclosure, as viewed from a front end side thereof.

FIG. 2 is a perspective view of the cutting tool illustrated in FIG. 1 as viewed from a rear end side thereof.

FIG. 3 is a perspective view of the cutting tool illustrated in FIG. 1 as viewed from the front end side thereof.

FIG. 4 is a rear view of the cutting tool illustrated in FIG. 1 as viewed from the rear end side thereof.

FIG. 5 is a side view of the cutting tool illustrated in FIG. 1 as viewed in a direction of arrow Y1 in FIG. 3.

FIG. 6 is a side view of the cutting tool illustrated in FIG. 1 as viewed in a direction of arrow Y2 in FIG. 3.

FIG. 7 is a cross-sectional view taken along an arrow line VII-VII in FIG. 6.

FIG. 8 is a cross-sectional view taken along an arrow line VIII-VIII in FIG. 6.

FIG. 9 is a cross-sectional view taken along an arrow line IX-IX in FIG. 6.

FIG. 10 is a cross-sectional view taken along a line X-X in FIG. 5.

FIG. 11 includes schematic cross-sectional views (a) to (c) illustrating a shape of a first beam according to an embodiment. FIG. 11 includes a schematic cross-sectional view (d) illustrating a shape of a first beam according to a reference example.

FIG. 12 is a schematic perspective view illustrating a cross-sectional shape of the first beam.

FIG. 13 is a schematic diagram illustrating a step of a method for manufacturing a machined product of a non-limiting embodiment of the present disclosure.

FIG. 14 is a schematic diagram illustrating a step of the method for manufacturing a machined product of the non-limiting embodiment of the present disclosure.

FIG. 15 is a schematic diagram illustrating a step of the method for manufacturing a machined product of the non-limiting embodiment of the present disclosure.

### DESCRIPTION OF EMBODIMENTS

In the cutting tool described in Patent Document 3 described above, the rim has a linear shape in a view at a side of the front end. Accordingly, the gap between the rim and the central hub is narrowed, and improvement in chip discharge performance is required. If the cutting tool is used as a boring tool, a gap may be formed between the workpiece and the rim and the gap may be clogged with chips. Accordingly, there is a demand for a cutting tool with high versatility that can smoothly discharge chips to the outside even if used as a boring tool. The present disclosure relates to a cutting tool having excellent chip discharge performance.

A detailed description will be given below of a cutting tool and a method for manufacturing a machined product of an embodiment that is an example of the present disclosure with reference to the drawings. However, each of the figures, which will be referred to below, is a simplified representation of only main members necessary for description of the embodiments. Accordingly, the cutting tool may include any constituent member that is not illustrated in each of the drawings referred to. In addition, the dimensions of members in the respective figures do not accurately represent the actual dimensions of constituent members, the dimensional ratio of respective members, or the like.

A cutting tool 10 is, for example, a rotary tool, and a specific example thereof is a boring tool. The boring tool may be used for machining an inner peripheral surface of a cylindrical workpiece. In the following description, a side of the cutting tool 10 where a fourth cutting edge 85a is located is referred to as a front end side, and a side opposite to the front end side is referred to as a rear end side.

### Cutting Tool

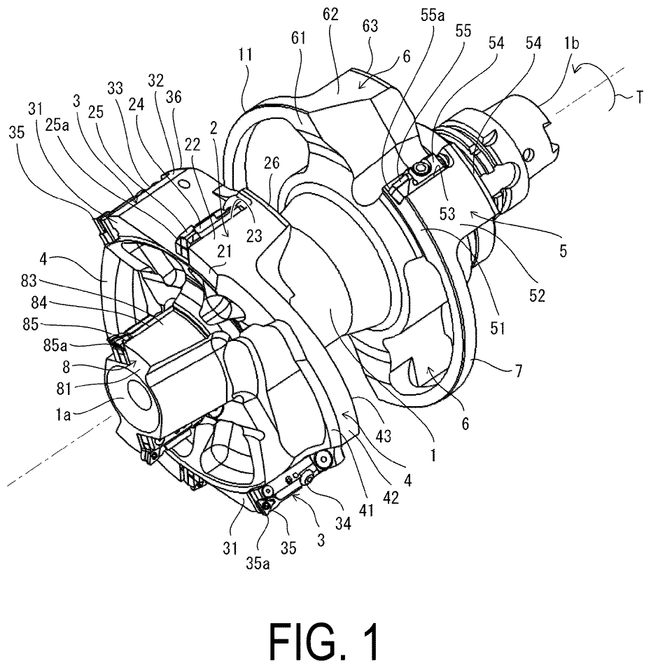

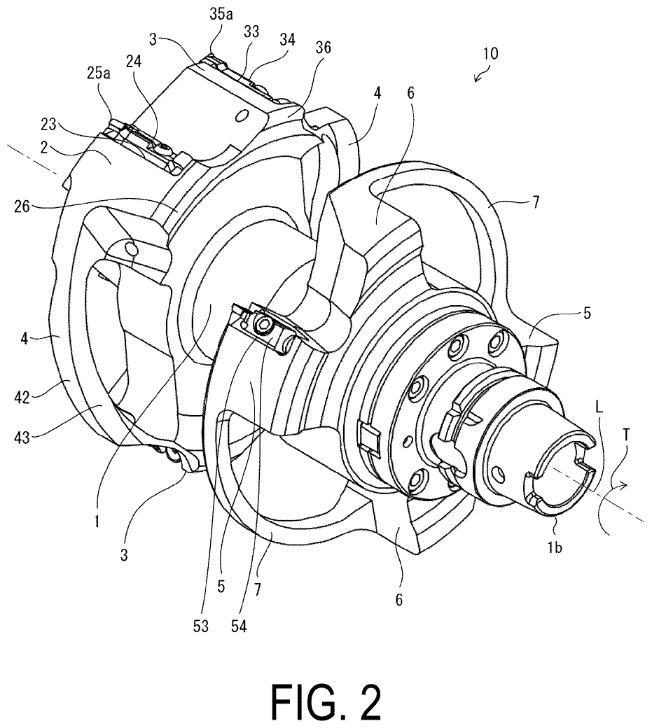

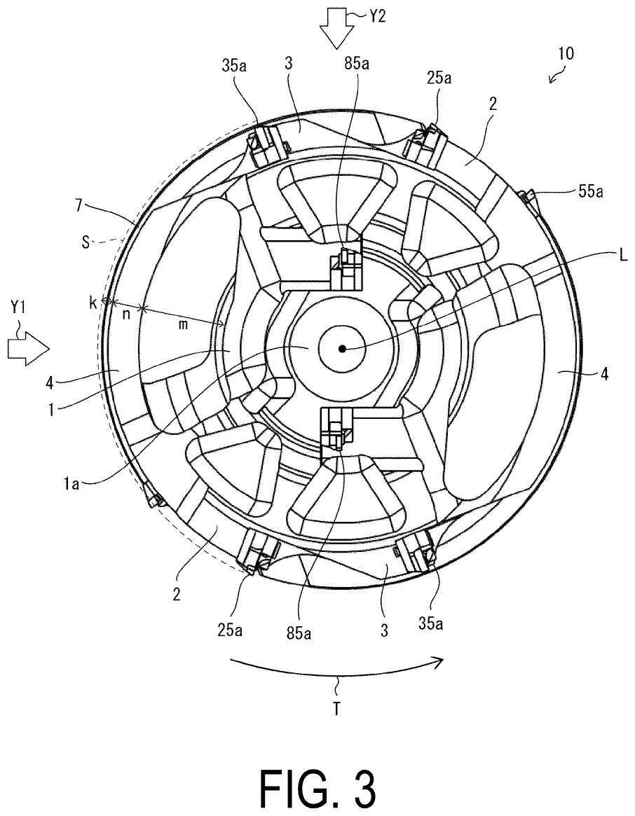

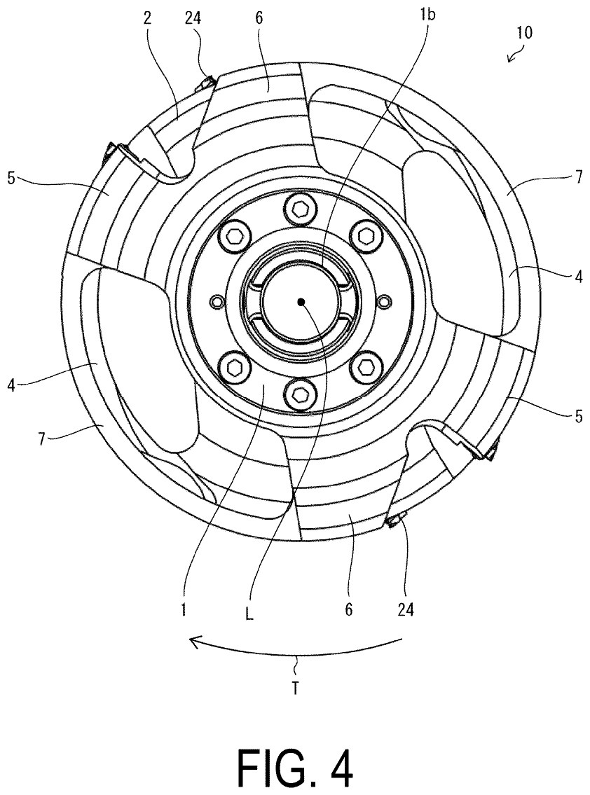

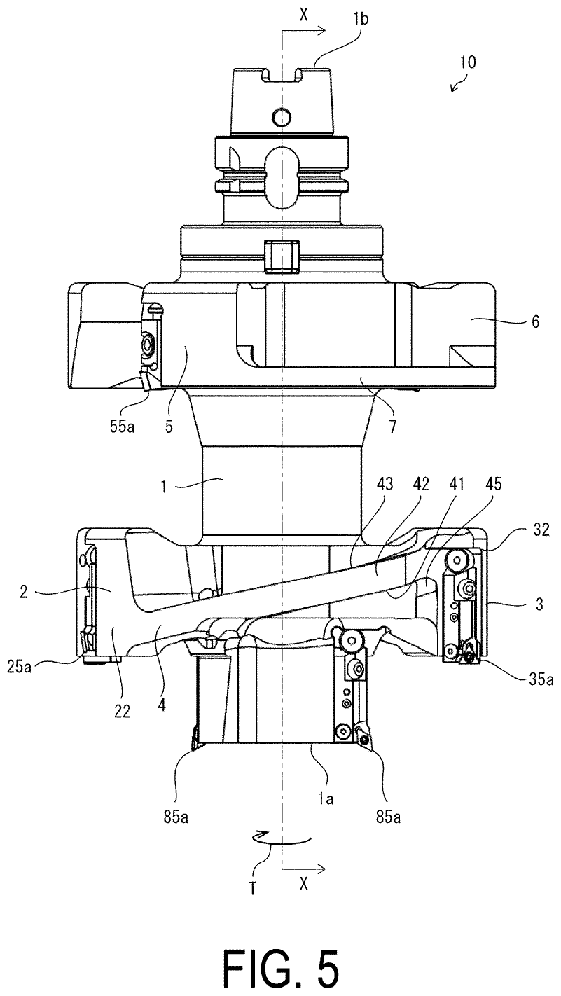

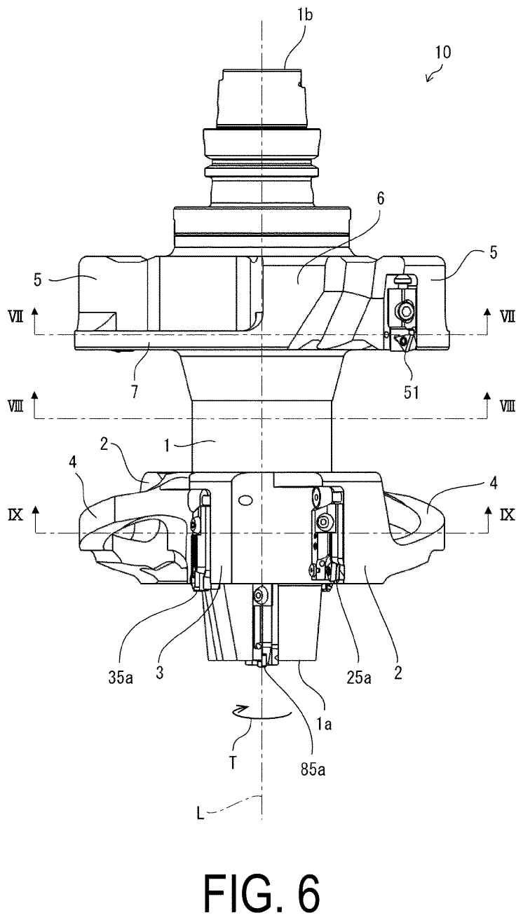

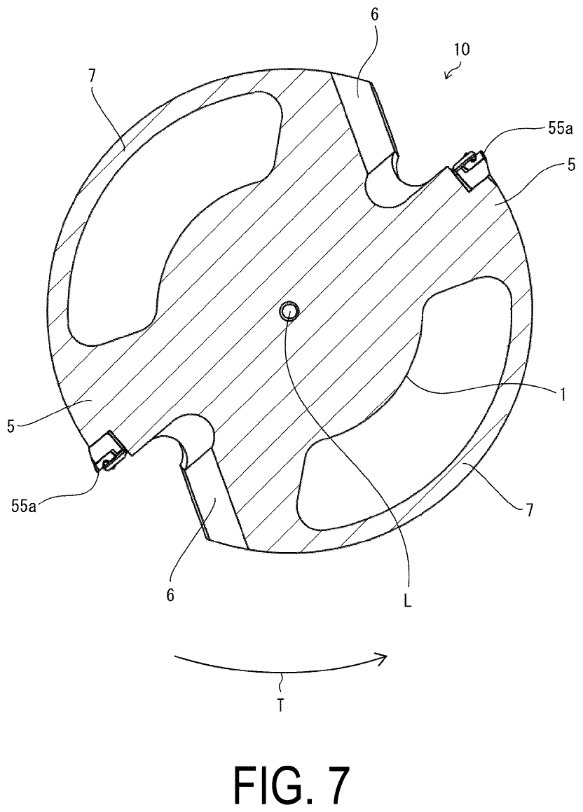

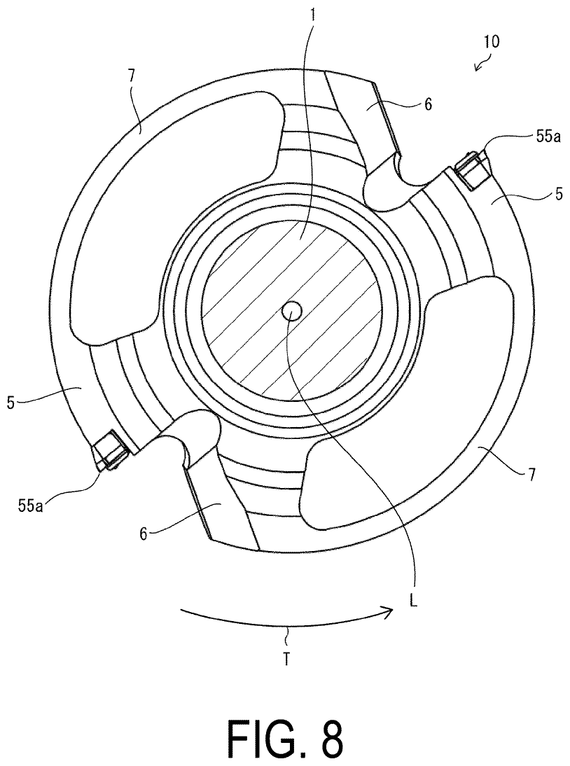

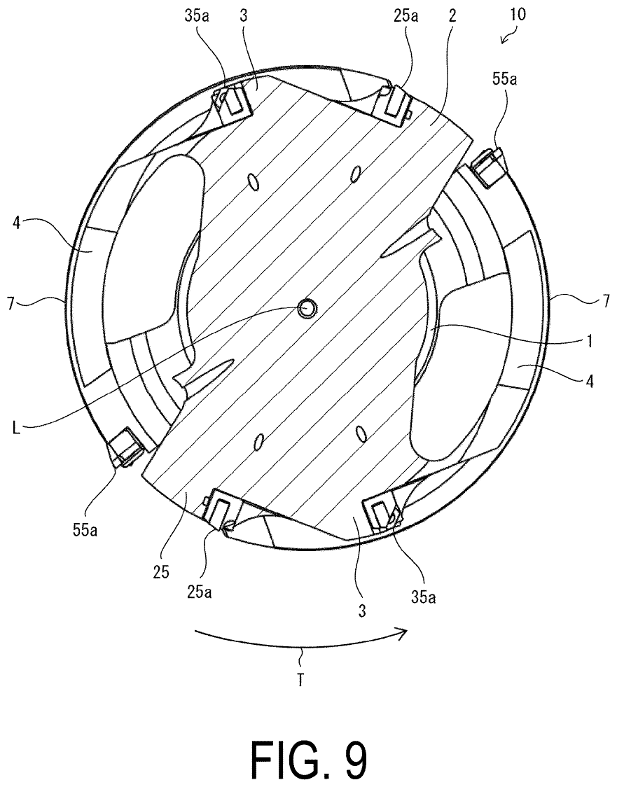

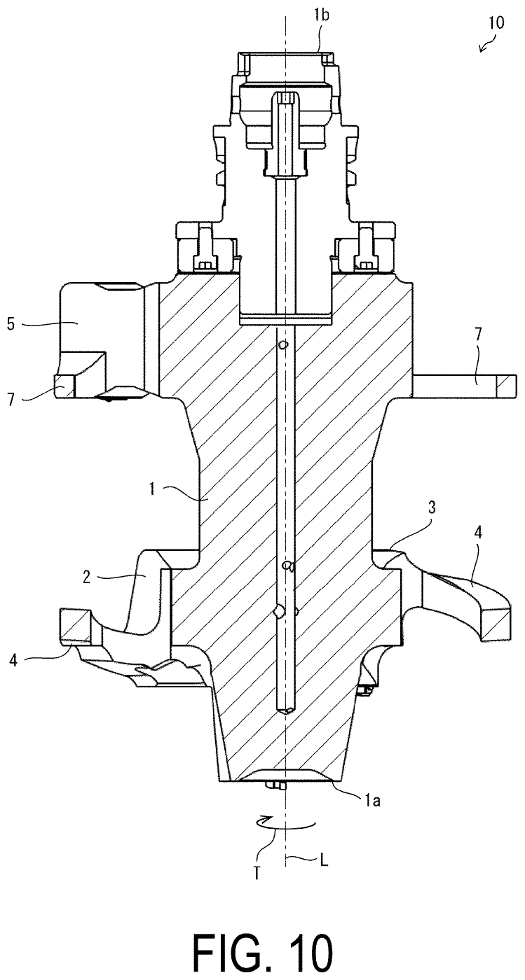

FIG. 1 is a perspective view illustrating the cutting tool 10 according to a first embodiment as viewed from a front end side thereof. FIG. 2 is a perspective view of the cutting tool 10 illustrated in FIG. 1 as viewed from a rear end side thereof. FIG. 3 is a front view of the cutting tool 10 illustrated in FIG. 1 as viewed from the front end side thereof. FIG. 4 is a rear view of the cutting tool 10 illustrated in FIG. 1 as viewed from the rear end side thereof. FIG. 5 is a side view of the cutting tool 10 illustrated in FIG. 1 as viewed in a direction of arrow Y1 in FIG. 3. FIG. 6 is a side view of the cutting tool 10 illustrated in FIG. 1 as viewed in a direction of arrow Y2 in FIG. 3. FIG. 7 is a cross-sectional view taken along an arrow line VII-VII in FIG. 6. FIG. 8 is a cross-sectional view taken along an arrow line VIII-VIII in FIG. 6. FIG. 9 is a cross-sectional view taken along an arrow line IX-IX in FIG. 6. FIG. 10 is a cross-sectional view taken along a line X-X in FIG. 5.

The cutting tool 10 of a non-limiting example illustrated in FIGS. 1 to 10 may include a shaft portion 1, a first protrusion 2, a second protrusion 3, a first beam 4, a third protrusion 5, a fourth protrusion 6, a second beam 7, and a fifth protrusion 8.

Examples of materials of the shaft portion 1, the first protrusion 2, the second protrusion 3, the first beam 4, the third protrusion 5, the fourth protrusion 6, the second beam 7, and the fifth protrusion 8 of the cutting tool 10 include steel such as stainless steel, cast iron, and an aluminum alloy. In particular, if steel is used among these materials, the toughness of the members described above is high. These members may be integrally formed or may be individually formed. If these members are individually formed, the cutting tool 10 may be configured by assembling these members.

### Shaft Portion

The shaft portion 1 may have a cylindrical shape extending along a rotation axis (central axis) L of the cutting tool 10 from a front end 1a toward a rear end 1b.

The size of the shaft portion 1 is not particularly limited. For example, the length in a direction along the rotation axis L may be set to from about 150 mm to 300 mm. The diameter of the shaft portion 1 corresponding to the thickness of the shaft portion 1 may be set to about 50 mm to 120 mm.

### First Protrusion

The first protrusion 2 protrudes from the shaft portion 1 toward an outer periphery. The first protrusion 2 is not limited to a configuration extending in a direction orthogonal to the rotation axis L, as illustrated in FIGS. 1 and 3. The first protrusion 2 may extend in a state of being inclined with respect to the rotation axis L. The first protrusion 2 may have a front end surface 21, an outer peripheral surface 22, a pocket 23, a cartridge 24, a cutting insert 25, a first cutting edge 25a, and a rear end surface 26.

The front end surface 21 may be located on the front end 1a side of the shaft portion 1 and on an outer periphery side of the shaft portion 1. The front end surface 21 is not limited to a configuration orthogonal to the rotation axis L. The front end surface 21 may be inclined with respect to the rotation axis L.

The rear end surface 26 may be located on the rear end 1b side of the shaft portion 1 and on the outer periphery side of the shaft portion 1. The rear end surface 26 is not limited to a configuration orthogonal to the rotation axis L. The rear end surface 26 may be inclined with respect to the rotation axis L.

The outer peripheral surface 22 may connect the front end surface 21 and the rear end surface 26 and form a curved surface shape along the outer periphery of the shaft portion 1. The pocket 23 may be located on the front end 1a side of the outer peripheral surface 22. For example, the pocket 23 may be formed by being cut out in a state where a portion on the rear end surface 26 side is left in a front direction of a rotation direction T of the outer peripheral surface 22. The pocket 23 may be continuous with the front end surface 21 or may extend from the front end surface 21 toward the rear end 1b. The cartridge 24 can be attached to the pocket 23.

The cartridge 24 located in the pocket 23 is not limited to a particular shape. The cartridge 24 may have a rectangular plate shape. The cartridge 24 may extend from the front end surface 21 toward the rear end 1b. The cutting insert 25 may be located on the front end surface 21 side (end portion of the outer periphery) of the cartridge 24. The cutting insert 25 may have a rod shape, a polygonal plate shape, or a polygonal column shape. In the present embodiment, the cutting insert 25 has a rhombic plate shape as illustrated in FIG. 5.

Examples of a material of the cutting insert 25 include cemented carbide alloy and cermet. The composition of the cemented carbide alloy may include WC—Co, WC—TiC—Co, and WC—TiC—TaC—Co, for example. Here, WC, TiC and TaC may be hard particles, and Co may be a binder phase.

The cermet may be a sintered composite material in which metal is combined with a ceramic component. Examples of the cermet may include titanium compounds in which one of titanium carbide (TiC) and titanium nitride (TiN) is a main component. The material of the cutting insert 25 is not limited to the composition described above.

A surface of the cutting insert 25 may be coated with a coating film formed using a chemical vapor deposition (CVD) method or a physical vapor deposition (PVD) method. Examples of the composition of the coating film may include titanium carbide (TiC), titanium nitride (TiN), titanium carbonitride (TiCN), and alumina (Al₂O₃).

If the cutting insert 25 has a rhombic plate shape, the first cutting edge 25a may be located at an intersection of two side surfaces sandwiching an apex on the front end 1a side of the cutting insert 25. Machining can be performed by bringing the first cutting edge 25a into contact with a workpiece 103 described below.

The cutting tool 10 may have two or more first protrusions 2. If two first protrusions 2 are provided, the two first protrusions 2 may be located so as to face each other and arranged so as to be point-symmetrical with respect to the rotation axis L. As illustrated in FIGS. 1 and 3, in the present embodiment, two first protrusions 2 are arranged so as to face each other with respect to the rotation axis L.

### Second Protrusion

The second protrusion 3 protrudes from the shaft portion 1 toward the outer periphery. The second protrusion 3 is not limited to a configuration extending in a direction orthogonal to the rotation axis L as illustrated in FIGS. 1 and 3. The second protrusion 3 may extend in a state of being inclined with respect to the rotation axis L. The second protrusion 3 may have a front end surface 31, an outer peripheral surface 32, a pocket 33, a cartridge 34, a cutting insert 35, a second cutting edge 35a, and a rear end surface 36.

The front end surface 31 may be located on the front end 1a side of the shaft portion 1 and on the outer periphery side of the shaft portion 1. The front end surface 31 is not limited to a configuration orthogonal to the rotation axis L. For example, the front end surface 31 may be inclined with respect to the rotation axis L.

The rear end surface 36 may be located on the rear end 1b side of the shaft portion 1 and on the outer periphery side of the shaft portion 1. The rear end surface 36 is not limited to a configuration orthogonal to the rotation axis L. For example, the rear end surface 36 may be inclined with respect to the rotation axis L.

The outer peripheral surface 32 may connect the front end surface 31 and the rear end surface 36 and may have a curved surface shape along the outer periphery of the shaft portion 1. The pocket 33 may be located on the front end 1a side of the outer peripheral surface 32. For example, the pocket 23 may be formed by being cut out in a state where a portion on the rear end surface 36 side is left in the front direction of the rotation direction T of the outer peripheral surface 32. The pocket 23 may be continuous with the front end surface 31 or may extend from the front end surface 31 toward the rear end 1b. The cartridge 34 can be attached to the pocket 33.

The cartridge 34 located in the pocket 33 is not limited to a particular shape. The

cartridge 34 may have a rectangular plate shape. The cartridge 34 may extend from the front end surface 31 toward the rear end 1b. The cutting insert 35 may be located on the front end surface 31 side (end portion of the outer periphery) of the cartridge 34. The cutting insert 35 may have a rod shape, a polygonal plate shape, or a polygonal column shape. In the present embodiment, the cutting insert 35 has a triangular plate shape as illustrated in FIG. 5.

The material of the cutting insert 35 is the same as the material of the cutting insert 25. If the cutting insert 35 has a triangular plate shape, the second cutting edge 35a may be located at an intersection of two side surfaces sandwiching an apex on the front end 1a side of the cutting insert 35.

The cutting tool 10 may have two or more second protrusions 3. If two second protrusions 3 are provided, the two second protrusions 3 may be located so as to face each other and arranged so as to be point-symmetrical with respect to the central axis. As illustrated in FIGS. 1 and 3, in the present embodiment, two second protrusions 3 are arranged so as to face each other with respect to the rotation axis L.

As illustrated in FIG. 5, the second protrusion 3 may be located behind the first protrusion 2 with respect to the rotation direction T of the rotation axis L. For example, as illustrated in FIGS. 1 and 3, it is assumed that two first protrusions 2 and two second protrusions 3 are arranged. In this case, a first protrusion 2 and a second protrusion 3 that are not connected by the first beam 4 described below may be adjacent to each other in a peripheral direction of the cutting tool 10, as illustrated in FIGS. 1 to 3. The first protrusion 2 and the second protrusion 3 may be connected to each other via a recessed portion recessed toward a center (rotation axis L) of the shaft portion 1.

### First Beam

As illustrated in FIGS. 2 and 5, the first beam 4 is located away from the shaft portion 1 and connected to the first protrusion 2 and the second protrusion 3. The second protrusion 3 is located behind the first protrusion 2 with respect to the rotation direction T.

As illustrated in FIG. 3, the first beam 4 may have a projecting shape protruding outward in a view from the front end 1a.

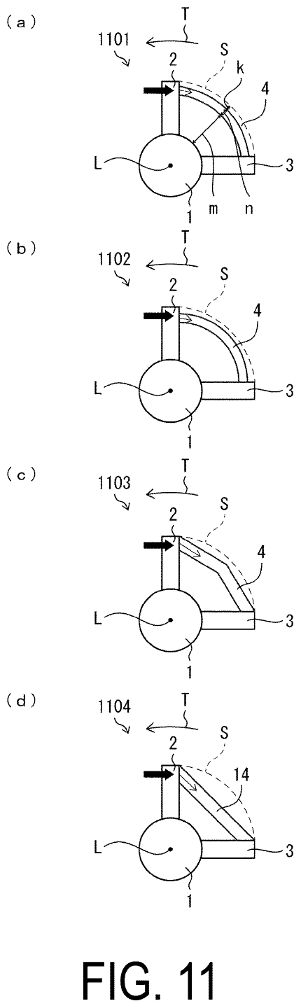

FIG. 11 is a view illustrating a relationship between a shape of the first beam 4 and a cutting load applied to the first beam 4 in each shape according to an embodiment and a reference example. Specifically, the shape of the first beam 4 according to the embodiment is illustrated in (a) to (c) in FIG. 11, and the shape of the first beam 4 according to the reference example is illustrated in (d) in FIG. 11. In FIG. 11, for convenience of description, it is assumed that the first protrusion 2 and the second protrusion 3 connected by the first beam 4 are arranged to form an angle of 90° in a view at a side of the front end 1a of the shaft portion 1.

As indicated by reference numeral 1102 in FIG. 11 ((b) in FIG. 11), the first beam 4 may have a projecting curve shape curved toward the outer periphery. In the drawing, a circumscribed circle of the cutting tool 10 in the view at the side of the front end 1a, in other words, a circumscribed circle with which the cutting edge of the cutting tool 10 comes into contact is indicated by S. The first beam 4 may have an arc shape curved toward the outer periphery as indicated by reference numeral 1101 in FIG. 11 ((a) in FIG. 11). The arc may have a shape along an arc of the circumscribed circle S if a circumscribed circle of the cutting tool 10, in other words, the circumscribed circle S into which the cutting edge of the cutting tool 10 is brought into contact is set in the view at the side of the front end 1a. Alternatively, the first beam 4 may have a shape in which a straight line is bent as indicated by reference numeral 1103 in FIG. 11 ((c) in FIG. 11).

The first beam 4 may have a projecting shape protruding outward, and a portion protruding to the outermost periphery may be located inside the circumscribed circle S. Therefore, as indicated by reference numeral 1103 in FIG. 11 ((c) in FIG. 11), the shape may be a bent line shape instead of a curved line shape.

As indicated by reference numerals 1101 to 1103 in FIG. 11 ((a) to (c) in FIG. 11), if the first beam 4 has a projecting shape, a gap between the shaft portion 1 and the first beam 4 can be widened compared to the case of reference numeral 1104 in FIG. 11 ((d) in FIG. 11) having the beam 14 having a linear shape. As a result, chips are likely to flow in this gap. Since the gaps between the first beam 4 and the circumscribed circle S indicated by the reference numerals 1101 to 1103 are smaller than the gap between the beam 14 and the circumscribed circle S indicated by the reference numeral 1104, the gaps are less likely to be clogged with chips. Since a large amount of chips can be caused to flow inside the first beam 4 and the amount of chips flowing outside the first beam 4 where a machined surface is present can be reduced, the likelihood of damaging the machined surface can be reduced.

As indicated by a thick black arrow in FIG. 11, a main component force of the cutting load generated at the first cutting edge 25a is applied rearward in the rotation direction T of the cutting tool 10. An angle formed by the direction in which the first beam 4 extends and the direction of the main component force at the portion of the first beam 4 connected to the first protrusion 2 indicated by the reference numerals 1101 to 1103 is smaller than an angle in the beam 14 having a linear shape indicated by the reference numeral 1104. That is, the main component force can be easily received by the first beam 4. Therefore, in addition to the chip discharge performance, the durability of the cutting tool 10 is improved.

In the case of the first beam 4 indicated by the reference numeral 1102 in FIG. 11, the angle formed by the direction in which the first beam 4 extends and the direction of the main component of force at the portion of the first beam 4 connected to the first protrusion 2 is smaller than that of the first beam 4 bent as indicated by the reference numeral 1103, so the applied cutting load is more easily absorbed. The likelihood of chips being caught between the first beam 4 and the machined surface is small. In the case of the first beam 4 indicated by the reference numeral 1103, a load is likely to be applied to a bent portion. As the shape changes from the bent line shape indicated by the reference numeral 1103 to the projecting curve shape indicated by the reference numeral 1102 and to the arc shape indicated by the reference numeral 1101, the cutting load is more easily absorbed. Since the curve shape is more easily bent than the bent line shape, the force for receiving the load is increased by the bending, and the durability is excellent.

If the first beam 4 has an arc shape as indicated by the reference numeral 1101 in FIG. 11, the cutting load can be more easily absorbed by the first beam 4. The chips are less likely to be caught between the first beam 4 and the machined surface, and the likelihood that the first beam 4 comes into contact with the workpiece 103 during cutting is lower than that of the first beam 4 indicated by the reference numeral 1102.

The first beam 4 may have a front end surface 41, an outer peripheral surface 42, and a rear end surface 43. The front end surface 41 is located on the front end 1a side of the shaft portion 1. The rear end surface 43 is located on the rear end 1b side of the shaft portion 1. The outer peripheral surface 32 is a surface connecting the front end surface 31 and the rear end surface 36.

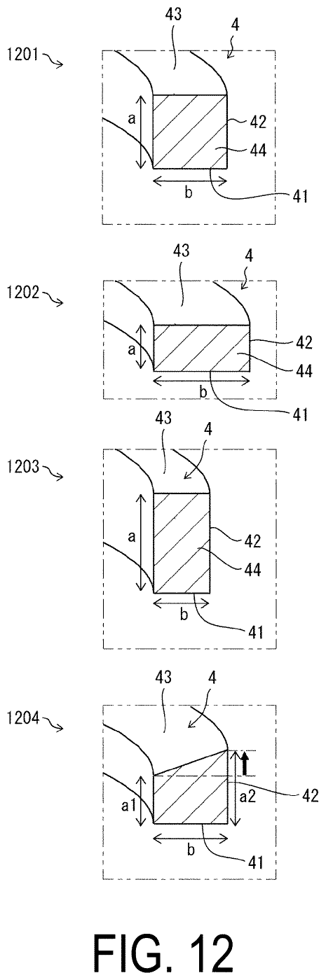

FIG. 12 is a schematic perspective view illustrating a cross-sectional shape of the first beam 4. In FIG. 12, a dimension a is a dimension in a direction along the rotation axis L, and a dimension b is a dimension in a direction orthogonal to the rotation axis L. A cross section 44 of the first beam 4 indicated by reference numeral 1201 in FIG. 12 has a substantially square shape in which the dimension a is substantially equal to the dimension b.

A cross section 44 of the first beam 4 indicated by reference numeral 1202 in FIG. 12 has a substantially rectangular shape in which the dimension a is smaller than the dimension b. That is, the cross section has such a flat shape that the dimension a in the direction along the rotation axis L is smaller than the dimension b in the direction orthogonal to the rotation axis L. In this case, the first beam 4 is less likely to be bent in a radial direction and less likely to come into contact with the machined surface of the workpiece 103. An effect of pushing out chips toward the rear end 1b side is also large.

A cross section 44 of the first beam 4 indicated by reference numeral 1203 in FIG. 12 has a substantially rectangular shape in which the dimension a is larger than the dimension b. In other words, the cross section has such a flat shape that the dimension a in the direction along the rotation axis L is larger than the dimension b in the direction orthogonal to the rotation axis L. In this case, a space on the inner periphery side of the first beam 4 can be increased.

A cross section 44 of the first beam 4 indicated by reference numeral 1204 in FIG. 12 has a substantially trapezoidal shape in which the dimension a is larger on the outer periphery side than on the inner periphery side. A dimension a2 on the outer periphery side is larger than a dimension al on the inner periphery side. In this case, the first beam 4 is less likely to be bent in the radial direction. When the chips are caused to flow rearward, the chips are directed not to the outer periphery side where the machined surface is present but to the inner periphery side, so that the chips are less likely to be brought into contact with the machined surface.

As indicated by reference numeral 1101 in FIG. 11 and illustrated in FIG. 3, in the first beam 4, an interval m between the shaft portion 11 and the first beam 4 may be larger than a dimension n of the first beam 4 in a direction (radial direction) orthogonal to the rotation axis L. In this case, the interval m can be made large so that a space through which chips flow can be easily secured.

As indicated by reference numeral 1101 in FIG. 11 and illustrated in FIG. 3, if a circumscribed circle S of the cutting tool is set, an interval k between the circumscribed circle S and the first beam 4 may be narrower than the interval m between the shaft portion 1 and the first beam 4. In this case, the space formed between the machined surface and the first beam 4 can be made small so that chips are less likely to be caught between the first beam 4 and the machined surface.

The first beam 4 may become closer to the rear end 1b as it approaches the second protrusion 3. That is, as illustrated in FIG. 5, the rear end surface 43 is inclined obliquely from the front end 1a toward the rear end 1b side. In this case, when the cutting tool 10 is rotated, it is easy to promote the flow of chips toward the rear end 1b in a screw shape. Even if a coolant is used, it is easy to promote the flow of the coolant toward the rear end 1b side and to discharge the chips.

The first beam 4 may be located further away from the front end 1a as it approaches the second protrusion 3. That is, as illustrated in FIG. 5, the front end surface 41 is inclined obliquely from the front end 1a toward the rear end 1b side. In this case, a space through which chips generated at the second cutting edge 35a flow can be secured. A chip pocket 45 is formed at a connecting portion where the first beam 4 connects with the second protrusion 3, and it is easy to cause the chips generated from the second cutting edge 35a to flow toward the rear end 1b through the chip pocket 45. With such a configuration, as compared with a configuration in which a rear end portion of the first protrusion 2 and a rear end portion of the second protrusion 3 are connected to each other, it is possible to precisely receive the main component force applied to the first cutting edge 25a of the first protrusion 2 and to favorably discharge the chips generated at the second cutting edge 35a.

### Third Protrusion

The third protrusion 5 protrudes from the shaft portion 1 toward the outer periphery. The third protrusion 5 is not limited to a configuration extending in the direction orthogonal to the rotation axis L, as illustrated in FIG. 1. The third protrusion 5 may extend in a state of being inclined with respect to the rotation axis L. The third protrusion 5 may have a front end surface 51, an outer peripheral surface 52, a pocket 53, a cartridge 54, a cutting insert 55, a third cutting edge 55a, and a rear end surface 56.

The front end surface 51 may be located on the front end 1a side of the shaft portion 1. The front end surface 51 may be orthogonal to the rotation axis L or may be inclined with respect to the rotation axis L. The rear end surface 56 may be located on the rear end 1b side of the shaft portion 1. The rear end surface 56 may be orthogonal to the rotation axis L or may be inclined with respect to the rotation axis L.

The outer peripheral surface 52 may connect the front end surface 51 and the rear end surface 56 and form a curved surface shape along the outer periphery of the shaft portion 1. The pocket 53 may be located on the front end 1a side of the outer peripheral surface 52. For example, the pocket 53 may be formed by being cut out in a state where a portion on the rear end surface 56 side is left in the front direction of the rotation direction T of the outer peripheral surface 52, at the third protrusion 5 on an upper side in FIGS. 1 and 2. The pocket 53 may be continuous with the front end surface 31 or may extend from the front end surface 51 toward the rear end 1b. The cartridge 54 can be attached to the pocket 53.

The cartridge 54 located in the pocket 53 is not limited to a particular shape. The cartridge 54 may have a rectangular plate shape. The cartridge 54 may extend from the front end surface 51 toward the rear end 1b. The cutting insert 55 may be located on the front end surface 51 side (end portion of the outer periphery) of the cartridge 54. The cutting insert 55 may have a rod shape, a polygonal plate shape, or a polygonal column shape. In the present embodiment, the cutting insert 55 has a triangular plate shape as illustrated in FIG. 5.

The material of the cutting insert 55 is the same as the material of the cutting insert 25. If the cutting insert 55 has a triangular plate shape, the third cutting edge 55a may be located at an intersection of two side surfaces sandwiching an apex on the front end 1a side of the cutting insert 55.

The cutting tool 10 may have two or more third protrusions 5. If two third protrusions 5 are provided, the two third protrusions 5 may be located so as to face each other and arranged so as to be point-symmetrical with respect to the rotation axis L. As illustrated in FIG. 2, in the present embodiment, two third protrusions 5 are arranged so as to face each other with respect to the rotation axis L.

### Fourth Protrusion

The fourth protrusion 6 protrudes from the shaft portion 1 toward the outer periphery. The fourth protrusion 6 is not limited to a configuration extending in a direction orthogonal to the rotation axis L as illustrated in FIG. 1. The fourth protrusion 6 may extend in a state of being inclined with respect to the rotation axis L. The fourth protrusion 6 may have a front end surface 61, an outer peripheral surface 62, and a rear end surface 63.

The front end surface 61 may be located on the front end 1a side of the shaft portion 1. The front end surface 61 may be orthogonal to the rotation axis L or may be inclined with respect to the rotation axis L. The rear end surface 63 may be located on the rear end 1b side of the shaft portion 1. The rear end surface 63 may be orthogonal to the rotation axis L or may be inclined with respect to the rotation axis L.

The outer peripheral surface 62 may connect the front end surface 61 and the rear end surface 63 and form a curved surface shape along the outer periphery of the shaft portion 1.

The cutting tool 10 may have two or more fourth protrusions 6. If two fourth protrusions 6 are provided, the two fourth protrusions 6 may be located so as to face each other and arranged so as to be point-symmetrical with respect to the central axis. As illustrated in FIG. 2, in the present embodiment, two third protrusions 5 are arranged so as to face each other with respect to the rotation axis L.

The fourth protrusion 6 may be located behind the third protrusion 5 with respect to the rotation direction T of the rotation axis L. The third protrusion 5 and the fourth protrusion 6 may be located closer to the rear end 1b side than the first protrusion 2 and the second protrusion 3. The third protrusion 5 and the fourth protrusion 6 may be adjacent to each other in the peripheral direction of the cutting tool 10 illustrated in FIG. 3. The third protrusion 5 and the fourth protrusion 6 may be connected in the peripheral direction of the cutting tool 10.

### Second Beam

The second beam 7 is located away from the shaft portion 1 and connected to the third protrusion 5 and the fourth protrusion 6. The second beam 7 may have a projecting shape protruding toward the outer periphery in the view at the side of the front end 1a. If the second beam 7 has a projecting shape, a gap between the shaft portion 1 and the second beam 7 can be widened compared to a case where the second beam 7 has a linear shape. As a result, chips are likely to flow in this gap.

The first beam 4 may become closer to the rear end 1b as it approaches the second protrusion 3, and the second beam 7 may extend in the direction orthogonal to the rotation axis L. Main cutting is performed by the first cutting edge 25a and the second cutting edge 35a on the front end 1a side. Since the third cutting edge 55a on the rear end 1b side is a finishing cut, the fourth protrusion 6 need not have a cutting edge. Therefore, it is not necessary to form a space (chip pocket) through which chips flow in the fourth protrusion 6.

### Fifth Protrusion

The fifth protrusion 8 protrudes from the shaft portion 1 toward the outer periphery at the front end 1a of the shaft portion 1. The fifth protrusion 8 is not limited to a configuration extending in the direction orthogonal to the rotation axis L as illustrated in FIGS. 1 and 3. The fifth protrusion 8 may extend in a state of being inclined with respect to the rotation axis L. The fifth protrusion 8 may have a front end surface 81, an outer peripheral surface 82, a pocket 83, a cartridge 84, a cutting insert 85, and a fourth cutting edge 85a.

The front end surface 81 may be located on the front end 1a side of the shaft portion 1. The front end surface 81 may be orthogonal to the rotation axis L or may be inclined with respect to the rotation axis L.

The outer peripheral surface 82 may be located on the outer periphery side of the fifth protrusion 8 and may have a curved surface shape along the outer periphery of the shaft portion 1. For example, the pocket 83 may be formed forward in the rotation direction T of the outer peripheral surface 82, at the fifth protrusion 8 on the upper side in FIGS. 1 and 2. The pocket 83 may be continuous with the front end surface 81 or may extend from the front end surface 81 toward the rear end 1b. The cartridge 84 can be attached to the pocket 83.

The cartridge 84 located in the pocket 83 is not limited to a particular shape. The cartridge 84 may have a rectangular plate shape. The cartridge 84 may extend from the front end surface 81 toward the rear end 1b. The cutting insert 85 may be located on the front end surface 81 side of the cartridge 84. The cutting insert 85 may have a rod shape, a polygonal plate shape, or a polygonal column shape. In the present embodiment, the cutting insert 85 has a rhombic plate shape as illustrated in FIG. 5.

A material of the cutting insert 85 is the same as the material of the cutting insert 25. If the cutting insert 85 has a rhombic plate shape, the fourth cutting edge 85a may be located at an intersection of two side surfaces sandwiching an apex on the front end 1a side of the cutting insert 55.

The cutting tool 10 may have two or more fifth protrusions 8. If two fifth protrusions 8 are provided, the two fifth protrusions 8 may be located so as to face each other and arranged so as to be point-symmetrical with respect to the central axis. As illustrated in FIG. 3, the fifth protrusion 8 may be located on a straight line in the radial direction with the first protrusion 2.

### Method for Manufacturing Machined Product

A method for manufacturing a machined product according to one non-limiting aspect of the present disclosure will be described with reference to the drawings. A case will be described in which a large-diameter hole 104 is formed in the workpiece 103 by the first cutting edge 25a, the second cutting edge 35a, and the third cutting edge 55a, and a small-diameter hole 105 is formed by the fourth cutting edge 85a.

A machined product 101 is manufactured by machining the workpiece 103. A method for manufacturing the machined product 101 in the embodiment includes the following steps. Specifically, the steps include:
(1) rotating the cutting tool 10;
(2) bringing the cutting tool 10 into contact with the workpiece 103; and
(3) separating the cutting tool 10 from the workpiece 103.

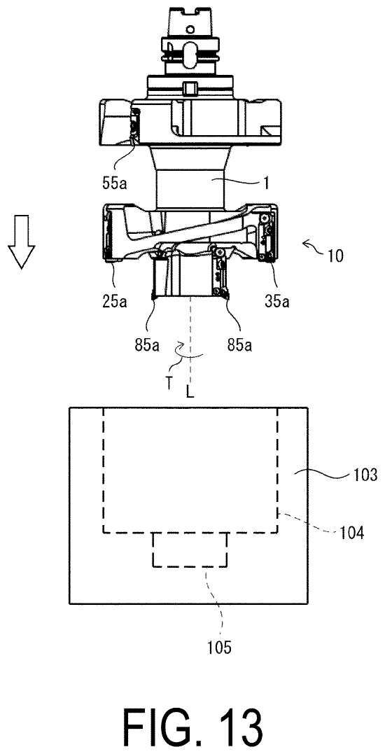

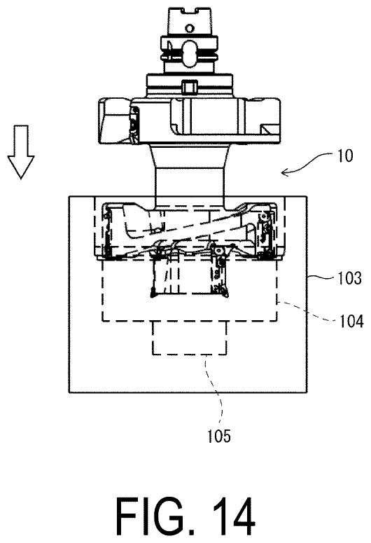

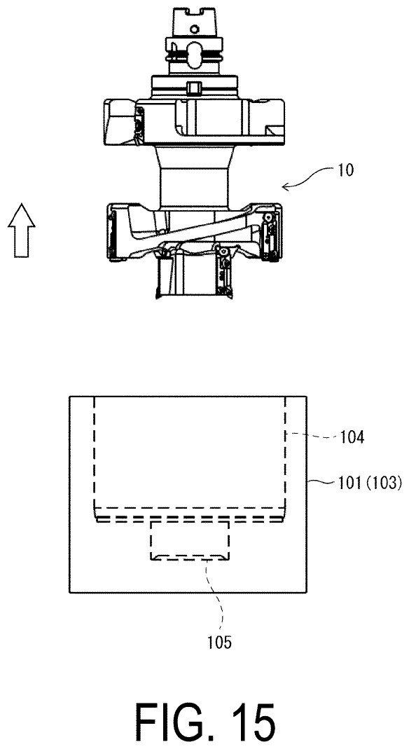

More specifically, first, as illustrated in FIG. 13, while the cutting tool 10 is made to rotate about the rotation axis L, the cutting tool 10 may be brought relatively close to the workpiece 103. Then, as illustrated in FIG. 14, at least a part of the cutting edge of the cutting tool 10 may be brought into contact with the workpiece 103 to cut the workpiece 103. Then, as illustrated in FIG. 15, the cutting tool 10 may be relatively moved away from the workpiece 103 (machined product 101).

As illustrated in FIG. 13, the cutting tool 10 may be brought close to the workpiece 103 by moving the rotating cutting tool 10 forward, in other words, downward in FIG. 13.

As illustrated in FIG. 14, the workpiece 103 may be cut by moving the cutting tool 10 forward in a state in which at least a part of the cutting edge is in contact with the workpiece 103.

As illustrated in FIG. 15, the cutting tool 10 may be moved away from the workpiece 103 by moving the rotating cutting tool 10 rearward, in other words, upward in FIG. 13.

By moving the cutting tool 10 in each step, the cutting tool 10 is brought into contact with the workpiece 103 or the cutting tool 10 is separated from the workpiece 103. However, the present configuration is not limited to such a case.

For example, in step (1), the workpiece 103 may be brought close to the cutting tool 10. In step (3), the workpiece 103 may be moved away from the cutting tool 10. When continuing the machining, a step of bringing at least a part of the cutting edge into contact with different locations of the workpiece 103 while the cutting tool 10 is kept rotating may be repeated.

Representative examples of the material of the workpiece 103 may include hardened steel, carbon steel, alloy steel, stainless steel, cast iron, non-ferrous metals, or the like.

In the present disclosure, the invention has been described above based on the various drawings and embodiments. However, the invention according to the present disclosure is not limited to each embodiment described above. That is, the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

1 Shaft portion
2 First protrusion
21, 31, 51, 61 Front end surface
22, 32, 52, 62 Outer peripheral surface
23, 33, 53 Pocket
24, 34, 54 Cartridge
25, 35, 55 Cutting insert
25a First cutting edge
26, 36, 56, 63 Rear end surface
3 Second protrusion
35a Second cutting edge
4 First beam
41 Front end surface
42 Outer peripheral surface
43 Rear end surface
5 Third protrusion
55a Third cutting edge
7 Second beam
10 Cutting tool
L Rotation axis
T Rotation direction

1. A cutting tool comprising:
a shaft portion having a cylindrical shape and extending along a rotation axis from a front end toward a rear end;
a first protrusion protruding from the shaft portion toward an outer periphery and having a first cutting edge at an end portion of the outer periphery;
a second protrusion protruding from the shaft portion toward the outer periphery and having a second cutting edge at an end portion of the outer periphery; and
a first beam located away from the shaft portion and connected to the first protrusion and the second protrusion, wherein
the second protrusion is located behind the first protrusion with respect to a rotation direction of the rotation axis, and
the first beam has a projecting shape protruding toward the outer periphery in a view at a side of the front end.

2. The cutting tool according to claim 1, wherein
the first beam has a projecting curve shape curved toward the outer periphery in the view at the side of the front end.

3. The cutting tool according to claim 2, wherein
the first beam has an arc shape curved toward the outer periphery in the view at the side of the front end.

4. The cutting tool according to claim 1, wherein
in a cross section including the rotation axis, the first beam has a flat shape in which a dimension in a direction along the rotation axis is smaller than a dimension in a direction orthogonal to the rotation axis.

5. The cutting tool according to claim 1, wherein
in a cross section including the rotation axis, an interval between the shaft portion and the first beam is larger than a dimension of the first beam in a direction orthogonal to the rotation axis.

6. The cutting tool according to claim 1, wherein
when a circumscribed circle of the cutting tool is set in the view at the side of the front end, an interval between the circumscribed circle and the first beam is narrower than an interval between the shaft portion and the first beam.

7. The cutting tool according to claim 1, wherein
the first beam becomes closer to the rear end as it approaches the second protrusion.

8. The cutting tool according to claim 1, wherein
the first beam becomes located further away from the front end as it approaches the second protrusion.

9. The cutting tool according to claim 1, further comprising:
a third protrusion protruding from the shaft portion toward the outer periphery and having a third cutting edge at an end portion of the outer periphery;
a fourth protrusion protruding from the shaft portion toward the outer periphery; and
a second beam located away from the shaft portion and connected to the third protrusion and the fourth protrusion, wherein
the fourth protrusion is located behind the third protrusion with respect to the rotation direction of the rotation axis,
the third protrusion and the fourth protrusion are located closer to a side of the rear end than the first protrusion and the second protrusion, and
the second beam has a projecting shape protruding toward an outer periphery in the view at the side of the front end.

10. The cutting tool according to claim 9, wherein
the first beam becomes closer to the rear end as it approaches the second protrusion, and
the second beam extends in a direction orthogonal to the rotation axis.

11. A method for manufacturing a machined product, the method comprising:
rotating the cutting tool according to claim 1;
bringing the cutting tool into contact with a workpiece; and
separating the cutting tool from the workpiece.
